(19) United States
(12) Patent Application Publication
(10) Pub. No.: US 2014/0023908 A1
(43) Pub. Date: Jan. 23, 2014

(54) LITHIUM-ION SECONDARY BATTERY

(71) Applicants: Tomoyoshi Ueki, Toyota-shi (JP); Harunari Shimamura, Moriguchi-shi (JP); Yusuke Fukumoto, Moriguchi-shi (JP)

(72) Inventors: Tomoyoshi Ueki, Toyota-shi (JP); Harunari Shimamura, Moriguchi-shi (JP); Yusuke Fukumoto, Moriguchi-shi (JP)

(21) Appl. No.: 14/008,449

(22) PCT Filed: Mar. 28, 2011
(86) PCT No.: PCT/JP2011/057706

§ 371 Date: Sep. 27, 2013

(51) Int. Cl. H01M 2/16

(52) U.S. Cl. CPC H01M 2/1686
USPC 429/144

(57) ABSTRACT

The lithium-ion secondary battery 100 includes: a positive electrode current collector 221; a positive electrode active material layer 223 held on the positive electrode current collector 221; a negative electrode current collector 241; and a negative electrode active material layer 243 that is held on the negative electrode current collector 241 and covers the positive electrode active material layer 223. A separator substrate 265 formed of a porous resin sheet is disposed between the positive electrode active material layer 223 and the negative electrode active material layer 243. The separator substrate 265 holds a heat-resistant layer 266. The heat-resistant layer 266 contains an inorganic filler, a binder and a thickener. The weight ratio P between the binder and the thickener (binder/thickener) in the heat-resistant layer is P<7.2.

### TECHNICAL FIELD

The present invention relates to a lithium-ion secondary battery. The term “lithium-ion secondary battery” as used herein refers to a secondary battery which utilizes lithium ions as electrolyte ions and is charged and discharged by transfer of electric charges accompanying lithium ions between positive and negative electrodes.

### BACKGROUND ART

With regard to lithium-ion secondary batteries, JP 2009-301765 A (Patent Literature 1) discloses an electrode containing a current collector and an active material layer formed thereon, and a porous protecting film provided on the surface of the active material layer containing fine particles, a binding agent, a surfactant and a thickener, wherein the fine particles may include an inorganic filler.

WO 2005/098997 A1 (Patent Literature 2), for example, discloses a non-aqueous electrolyte secondary battery containing a porous insulating film adhered on the surface of a positive or negative electrode, wherein the porous insulating film contains an inorganic filler and a film binding agent. This Patent Literature teaches that the porous insulating film needs to be adhered on the surface of the electrode. One of the reasons for this is explained by the fact that the porous insulating film adhered on a separator which has low heat resistance may be deformed when the separator is deformed at a high temperature.

### CITATION LIST

### Patent Literature

Patent Literature 1: JP 2009-301765 A
Patent Literature 2: WO 2005/098997 A1

### SUMMARY OF INVENTION

Patent Literature 1 and Patent Literature 2 disclose secondary batteries having, on the surface of a positive or negative electrode, a film containing an inorganic filler, while the present invention has been achieved by devising the formation of a heat resistant layer containing an inorganic filler on a separator. It is devised that a mixture of the inorganic filler, a binder and a thickener in a solvent is applied on the separator. However, the separator obtained by applying the mixture of the inorganic filler, the binder and the thickener in the solvent may increase resistance of batteries, of which reduction is desirable.

The lithium-ion secondary battery according to the present invention includes: a positive electrode current collector; a positive electrode active material layer held on the positive electrode current collector; a negative electrode current collector; and a negative electrode active material layer that is held on the negative electrode current collector and covers the positive electrode active material layer. A separator substrate formed of a porous resin sheet is disposed between the positive electrode active material layer and the negative electrode active material layer. The separator substrate holds a heat-resistant layer. The heat-resistant layer contains an inorganic filler, a binder and a thickener. The weight ratio P between the binder and the thickener in the heat-resistant layer (binder/thickener) is P<7.2.

The lithium-ion secondary battery can decrease the increasing rate of resistance even when the separator substrate holds the heat-resistant layer. Accordingly, the lithium-ion secondary battery having improved reliability can be obtained.

In this case, the weight ratio P between the hinder and the thickener (binder/thickener) may be 0.4≦P. The weight proportion of the hinder contained in the heat-resistant layer may be 0.4 wt % or more and 17.2 wt % or less. For example, the weight proportion of the hinder may be 2.0 wt % or more and 4.5 wt % or less.

The inorganic filler may be at least one inorganic filler selected from the group of alumina (Al₂O₃), alumina hydrates (e.g. boehmite (Al₂O₃.H₂O)), zirconia (ZrO₂), magnesia (MgO), aluminium hydroxide (Al(OH)₃), magnesium hydroxide (Mg(OH)₂) and magnesium carbonate (MgCO₃).

The binder may be at least one binder selected from the group of acrylic resins, styrene butadiene rubbers, polyolefin resins, polytetrafluoroethylene, polyvinylidene fluoride, polyacrylonitrile, poly-methyl methacrylate and polyacrylic acid.

The thickener may be at least one thickener selected from the group of carboxymethylcellulose, methylcellulose, polyacrylic acid and polyethylene oxide.

### BRIEF DESCRIPTION OF DRAWINGS

FIG. 1 is a view showing an example of the configuration of a lithium-ion secondary battery;

FIG. 2 is a view showing a wound electrode assembly of a lithium-ion secondary battery;

FIG. 3 is a section view showing the section along III-III of FIG. 2;

FIG. 4 is a section view showing the configuration of a positive electrode active material layer;

FIG. 5 is a section view showing the configuration of a negative electrode active material layer;

FIG. 6 is a side view showing a welded part between an uncoated part of a wound electrode assembly and an electrode terminal;

FIG. 7 is a view schematically showing the state of a lithium-ion secondary battery during charge;

FIG. 8 is a view schematically showing the state of a lithium-ion secondary battery during discharge;

FIG. 9 is a section view of a separator;

FIG. 10 is a view showing a type 18650 test battery;

FIG. 11 is a graph showing the relationship between the weight ratio P and the increasing rate of resistance when the thickener is carboxymethylcellulose;

FIG. 12 is a graph showing the relationship between the weight ratio P and the increasing rate of resistance when the thickener is methylcellulose;

FIG. 13 is a graph showing the relationship between the thickness of a heat-resistant layer and the increasing rate of resistance;

FIG. 14 is a view showing a vehicle containing a secondary battery; and

FIG. 15 is a process chart of an example of the step of formation of a heat-resistant layer.

### DESCRIPTION OF EMBODIMENTS

An example of configurations of lithium-ion secondary batteries is first described herein. The lithium-ion secondary battery according to an embodiment of the present invention is then described by referring to the configuration example. The members and parts having similar functions are appropriately designated by the same symbols. All figures are schematically depicted and do not always reflect the real matters. The figures merely depict examples and do not limit the present invention unless otherwise stated.

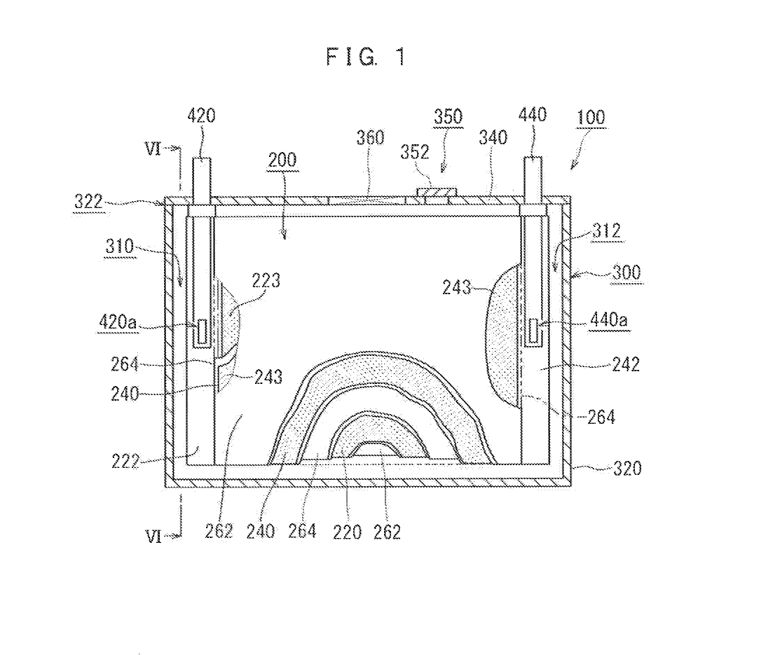

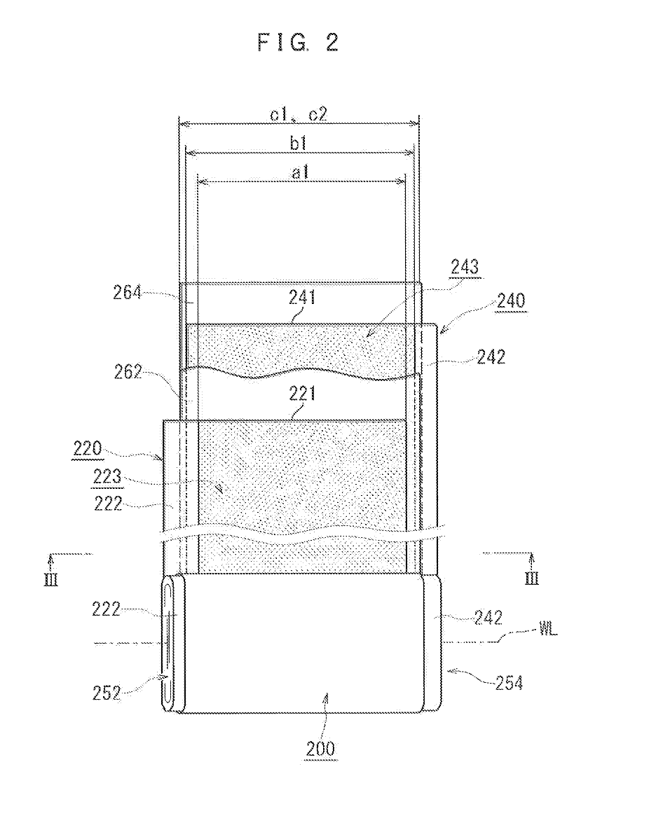

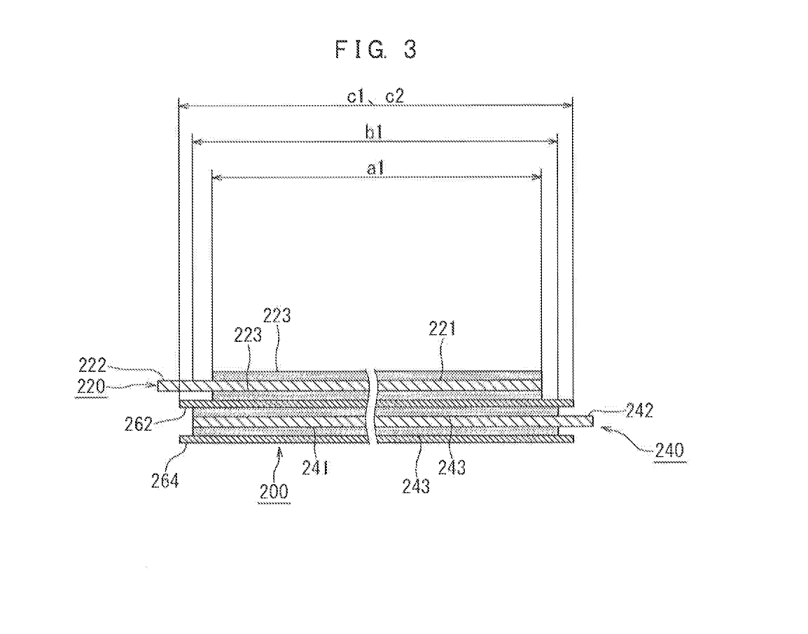

FIG. 1 shows a lithium-ion secondary battery 100. The lithium-ion secondary battery 100 comprises, as shown in FIG. 1, a wound electrode assembly 200 and a battery case 300. FIG. 2 shows the wound electrode assembly 200. FIG. 3 shows the section along III-III of FIG. 2.

The wound electrode assembly 200 has, as shown in FIG. 2, a positive electrode sheet 220, a negative electrode sheet 240 and separators 262 and 264. The positive electrode sheet 220, the negative electrode sheet 240 and the separators 262 and 264 are respectively strip-shaped sheet materials.

<<Positive Electrode Sheet 220>>

The positive electrode sheet 220 has a strip-shaped positive electrode current collector 221 and a positive electrode active material layer 223. The positive electrode current collector 221 may suitably contain a metal foil suitable for positive electrodes. The positive electrode current collector 221 may be, for example, a strip-shaped aluminium foil having a certain width and a thickness of about 15 μm. The positive electrode current collector 221 has an uncoated part 222 which is defined along the edge on one side in the width direction of the positive electrode current collector 221. In the example shown in the figures, the positive electrode current collector 221 includes, as shown in FIG. 3, the positive electrode active material layer 223 on each side of the positive electrode current collector 221 except for the uncoated part 222 thereon. The positive electrode active material layer 223 contains a positive electrode active material. The positive electrode active material layer 223 is formed by applying a positive electrode mixture containing the positive electrode active material on the positive electrode current collector 221.

<<Positive Electrode Active Material Layer 223 and Positive Electrode Active Material Particles 610>>

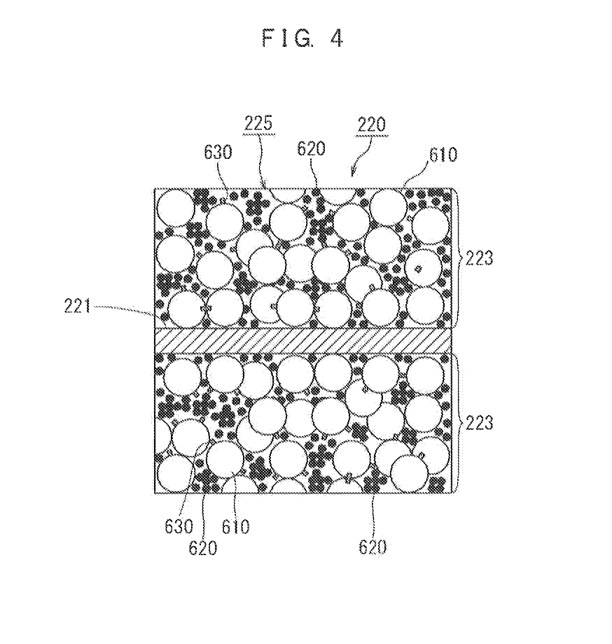

FIG. 4 is a section view of the positive electrode sheet 220. In FIG. 4, positive electrode active material particles 610, a conducting material 620 and a binder 630 in the positive electrode active material layer 223 are schematically enlarged in order to clearly show the structure of the positive electrode active material layer 223. The positive electrode active material layer 223 contains, as shown in FIG. 4, the positive electrode active material particles 610, the conducting material 620 and the binder 630.

The positive electrode active material particles 610 may be a material for positive electrode active materials of lithium-ion secondary batteries. Examples of the positive electrode active material particles 610 include lithium transition metal oxides such as LiNiCoMnO₂ (lithium nickel cobalt manganese composite oxide), LiNiO₂ (lithium nickel oxide), LiCoO₂ (lithium cobalt oxide), LiMn₂O₄ (lithium manganese oxide), LiFePO₄ (lithium iron phosphate) and the like. LiMn₂O₄ has, for example, the spinel structure. LiNiO₂ and LiCoO₂ have the laminar rock salt structure. LiFePO₄ has, for example, the olivine structure. LiFePO₄ having the olivine structure may include, for example, particles of the order of nanometers. LiFePO₄ having the olivine structure may be covered by a carbon film.

<<Conducting Material 620>>

The conducting material 620 may be exemplified by, for example, carbon materials such as carbon powder, carbon fiber and the like, from which one type or two or more types in combination may be used as the conducting material. Carbon powder may be various carbon black (e.g., acetylene black, oil furnace black, graphitized carbon black, carbon black, graphite, ketjen black), graphite powder and the like.

<<Binder 630>>

The binder 630 binds positive electrode active material particles 610 or particles of the conducting material 620 contained in positive electrode active material layer 223 and binds these particles with the positive electrode current collector 221. The binder 630 may be a polymer soluble or dispersible in a solvent used. For example, in a positive electrode mixture composition containing an aqueous solvent, water-soluble or water-dispersible polymers may be preferably used including cellulose polymers (carboxymethylcellulose (CMC), hydroxypropyl methylcellulose (TUNIC) and the like), fluororesins (polyvinyl alcohol (PVA), polytetrafluoroethylene (PTFE), tetrafluoroethylene-hexafluoropropylene copolymers (FEPs) and the like), rubbers (vinyl acetate copolymers, styrene butadiene copolymers (SBRs), acrylic SBR resins (SBR latexes) and the like). In a positive electrode mixture composition containing a non-aqueous solvent, polymers (polyvinylidene fluoride (PVDF), polyvinylidene chloride (PVDC), polyacrylonitrile (PAN) and the like) may be preferably used.

<<Thickener and Solvent>>

The positive electrode active material layer 223 may be formed, for example, by preparing the paste (slurry) positive electrode mixture from the positive electrode active material particles 610 and the conducting material 620 mixed in a solvent and applying the mixture on the positive electrode current collector 221 which is then dried and extended by applying pressure. The solvent for the positive electrode mixture may be any aqueous and non-aqueous solvents. A suitable non-aqueous solvent may be exemplified by N-methyl-2-pyrroridone (NMP). The polymer materials exemplified as the binder 630 may be used for, in addition to providing the function as a binder, providing the function as a thickener or other additives to the positive electrode mixture.

The mass ratio of the positive electrode active material in the whole positive electrode mixture is preferably about 50 wt % or more (typically 50 to 95 wt %) and is generally and more preferably about 70 to 95 wt % (e.g. 75 to 90 wt %). The ratio of the conducting material in the whole positive electrode mixture may be, for example, about 2 to 20 wt % and is generally and preferably about 2 to 15 wt %. When a binder is included in the composition, the ratio of the binder in the whole positive electrode mixture may be, for example, about 1 to 10 wt % and is generally and preferably about 2 to 5 wt %.

<<Negative Electrode Sheet 240>>

The negative electrode sheet 240 has, as shown in FIG. 2, a strip-shaped negative electrode current collector 241 and a negative electrode active material layer 243. The negative electrode current collector 241 may suitably contain a metal foil suitable for negative electrodes. The negative electrode current collector 241 contains a strip-Shaped copper foil having a certain width and a thickness of about 10 μm. The negative electrode current collector 241 has an uncoated part 242 which is defined along the edge on one side in the width direction of the negative electrode current collector 241. The negative electrode current collector 241 includes the negative electrode active material layer 243 on each side of the negative electrode current collector 241 except for the uncoated part 242 defined thereon. The negative electrode active material layer 243 is held on the negative electrode current collector 241 and contains at least a negative electrode active material. The negative electrode active material layer 243 is formed by applying a negative electrode mixture containing the negative electrode active material on the negative electrode current collector 241.

<<Negative Electrode Active Material Layer 243>>

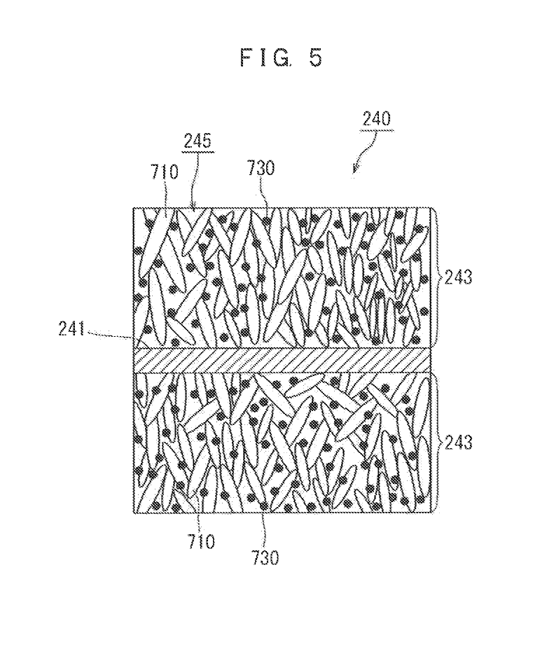

FIG. 5 is a section view of the negative electrode sheet 240 in the lithium-ion secondary battery 100. The negative electrode active material layer 243 contains, as shown in FIG. 5, a negative electrode active material 710, a thickener (not shown), a binder 730 and the like. In FIG. 5, the negative electrode active material 710 and the binder 730 in the negative electrode active material layer 243 are schematically enlarged in order to clearly show the structure of the negative electrode active material layer 243.

<<Negative Electrode Active Material>>

The negative electrode active material 710 may contain one, two or more materials conventionally used for lithium-ion secondary batteries without particular limitation. The negative electrode active material may include, for example, particulate carbon materials (carbon particles) at least partially having a graphite structure (laminar structure). More specifically, the negative electrode active material may be, for example, natural graphite, natural graphite coated with an amorphous carbon material thereon, graphite, hard carbon, soft carbon and combined carbon materials thereof. In the figures, the negative electrode active material 710 is exemplified by so-called flake graphite, which, however, does not limit the negative electrode active material 710.

<<Thickener and Solvent>>

The negative electrode active material layer 243 is formed, for example, by preparing a paste (slurry) negative electrode mixture from the negative electrode active material 710 and the binder 730 mixed in a solvent and applying the mixture on the negative electrode current collector 241 which is then dried and extended by applying pressure. The solvent for the negative electrode mixture may be any aqueous and non-aqueous solvents. A suitable non-aqueous solvent may include N-methyl-2-pyrroridone (NMP). The hinder 730 may be a polymer material exemplified as the binder 630 for the positive electrode active material layer 223 (see FIG. 4). The polymer material exemplified as the binder 630 for the positive electrode active material layer 223 may be used for, in addition to providing the function as a binder, providing the function as a thickener or other additives to the positive electrode mixture.

<<Separators 262 and 264>>

The separators 262 and 264 separate the positive electrode sheet 220 and the negative electrode sheet 240 as shown in FIG. 1 or 2. In this example, the separators 262 and 264 are formed by strip-shaped sheet materials having a plurality of minute pores and having a predetermined width. The separators 262 and 264 may be, for example, a single-layer separator or a laminated separator formed of a porous polyolefin resin. In this example, as shown in FIGS. 2 and 3, the negative electrode active material layer 243 has the width b1 slightly wider than the width a1 of the positive electrode active material layer 223. The separators 262 and 264 respectively has the width c1 and c2 slightly wider than the width b1 of the negative electrode active material layer 243 (c1 and c2>b1>a1).

In examples shown in FIGS. 1 and 2, the separators 262 and 264 are formed by sheet materials. The separators 262 and 264 may be any material which insulates between the positive electrode active material layer 223 and the negative electrode active material layer 243 while allowing transfer of an electrolyte. Thus the separator is not limited to a sheet material. The separators 262 and 264 may be formed by, instead of sheet materials, e.g. a layer of insulating particles formed on the positive electrode active material layer 223 or the negative electrode active material layer 243. The insulating particles may be an insulating inorganic filler (e.g. a filler such as metal oxides or metal hydroxides) or insulating resin particles (e.g. polyethylene or polypropylene particles).

<<Battery case 300>>

In this example, the battery case 300 is, as shown in FIG. 1, a so-called rectangular battery case comprising a case body 320 and a lid 340. The case body 320 is square tubular with a bottom and is a flat box-shaped container with one side (upper side) being opened. The lid 340 is a member provided at an opening (opening on the upper side) of the case body 320 in order to close the opening.

Secondary batteries for vehicles are desired to have improved weight energy efficiency (battery capacity per unit weight) in order to improve the fuel consumption of the vehicles. Therefore, in this embodiment, the case body 320 and the lid 340 of the battery case 300 are formed of a light-weight metal such as aluminum, aluminum alloy and the like. Accordingly the weight energy efficiency can be improved.

The battery case 300 has a flat and rectangular inner space for harboring the wound electrode assembly 200. As shown in FIG. 1, the flat inner space of the battery case 300 has a slightly wider horizontal width than that of the wound electrode assembly 200. In this embodiment, the battery case 300 includes a square tubular case body 320 with a bottom and a lid 340 for closing the opening of the case body 320. The lid 340 of the battery case 300 is attached with electrode terminals 420 and 440. The electrode terminals 420 and 440 penetrate the battery case 300 (lid 340) to be exposed at the outside of the battery case 300. The lid 340 is also provided with a liquid injection pore 350 and a safety valve 360.

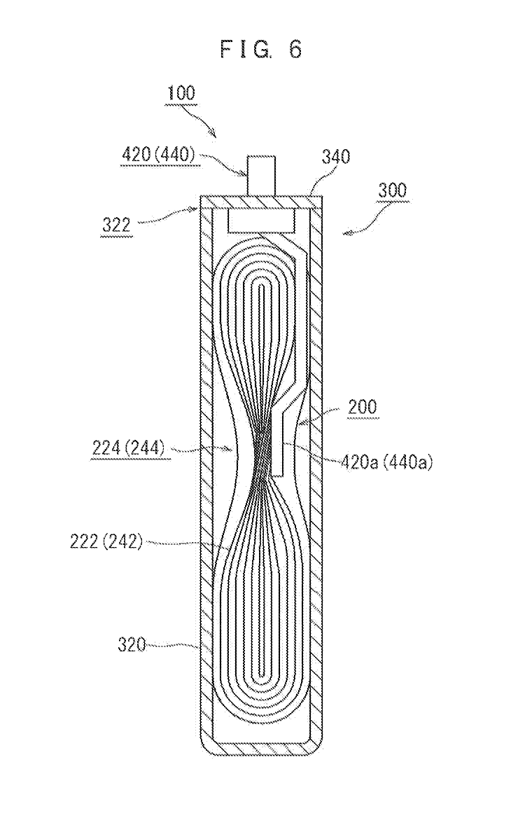

The wound electrode assembly 200 is, as shown in FIG. 2, pressed and bent in one direction perpendicular to the winding axis WL so as to be flat. In the example shown in FIG. 2, the uncoated part 222 of the positive electrode current collector 221 and the uncoated part 242 of the negative electrode current collector 241 are spirally exposed on both sides of the respective separators 262 and 264. As shown in FIG. 6, in this embodiment, the uncoated part 222 or 242 is brought together at its middle part 224 or 244 and weld onto the tip 420a or 440a of the electrode terminal 420 or 440, respectively. Because of the difference in materials, the electrode terminal 420 is welded to the positive electrode current collector 221 by, for example, ultrasonic welding. The electrode terminal 440 is welded to the negative electrode current collector 241 by, for example, resistance welding. FIG. 6 is a side view showing a welded part between the uncoated part of the wound electrode assembly and the electrode terminal and is a section view along VI-VI of FIG. 1.

The wound electrode assembly 200 is attached to the electrode terminals 420 and 440 fixed to the lid 340 while it is pressed and bent to be flat. The wound electrode assembly 200 is, as shown in FIG. 1, harbored in the flat inner space of the case body 320. The case body 320 harboring the wound electrode assembly 200 is closed with the lid 340. A joining part 322 (see FIG. 1) of the lid 340 and the case body 320 may be, for example, welded and sealed by laser welding. As described above, in this example, the wound electrode assembly 200 is positioned in the battery case 300 by means of the electrode terminals 420 and 440 fixed to the lid 340 (battery case 300).

### <<Electrolyte>>

An electrolyte is then injected into the battery case 300 through the liquid injection pore 350 provided on the lid 340. The electrolyte used is so-called non-aqueous electrolyte which does not contain water as a solvent. In this example, the electrolyte contains LiPF₆ at a concentration of about 1 mol/liter in a mixed solvent of ethylene carbonate and diethyl carbonate (e.g. mixed solvent of about 1:1 volume ratio). The liquid injection pore 350 is then attached with a metal sealing cap 352 (e.g. by welding) in order to seal the battery ease 300. The electrolyte is not limited to the one exemplified herein. The electrolyte may appropriately be, for example, any non-aqueous electrolyte conventionally used for lithium-ion secondary batteries.

<<Voids>>

The positive electrode active material layer 223 contains fine gaps 225 which may also be referred to as hollow spaces between, for example, the positive electrode active material particles 610 and the particles of the conducting material 620 (see FIG. 4). The electrolyte (not shown) can infiltrate into the fine gaps of the positive electrode active material layer 223. The negative electrode active material layer 243 contains fine gaps 245 which may also be referred to as hollow spaces between, for example, particles of the negative electrode active material 710 (see FIG. 5). The gaps 225 and 245 (hollow spaces) are herein appropriately referred to as “voids”. In the wound electrode assembly 200, as shown in FIG. 2, the uncoated parts 222 and 242 are spirally wound at both sides 252 and 254 along the winding axis WL. The electrolyte can infiltrate from the gaps in uncoated parts 222 and 242 on both sides 252 and 254 along the winding axis WL. Thus the lithium-ion secondary battery 100 contains the positive electrode active material layer 223 and the negative electrode active material layer 243 to which the electrolyte has been infiltrated.

<<Gas Evacuation Path>>

In this example, the fiat inner space of the battery case 300 is slightly larger than the wound electrode assembly 200 deformed to be flat. The wound electrode assembly 200 is provided with on both sides thereof gaps 310 and 312 between the wound electrode assembly 200 and the battery case 300, which serve as gas evacuation paths. In case of for example overcharge which results in abnormally increased temperature in the lithium-ion secondary battery 100, the electrolyte may be decomposed to abnormally produce gas. In this embodiment, the abnormally produced gas is transferred towards the safety valve 360 through the gaps 310 and 312 on both sides of the wound electrode assembly 200 and between the wound electrode assembly 200 and the battery case 300 and then exhausted outside the battery case 300 through the safety valve 360.

In the lithium-ion secondary battery 100, the positive electrode current collector 221 and the negative electrode current collector 241 are electrically connected to external devices through the electrode terminals 420 and 440 penetrating the battery case 300.

<<Behavior During Charge>>

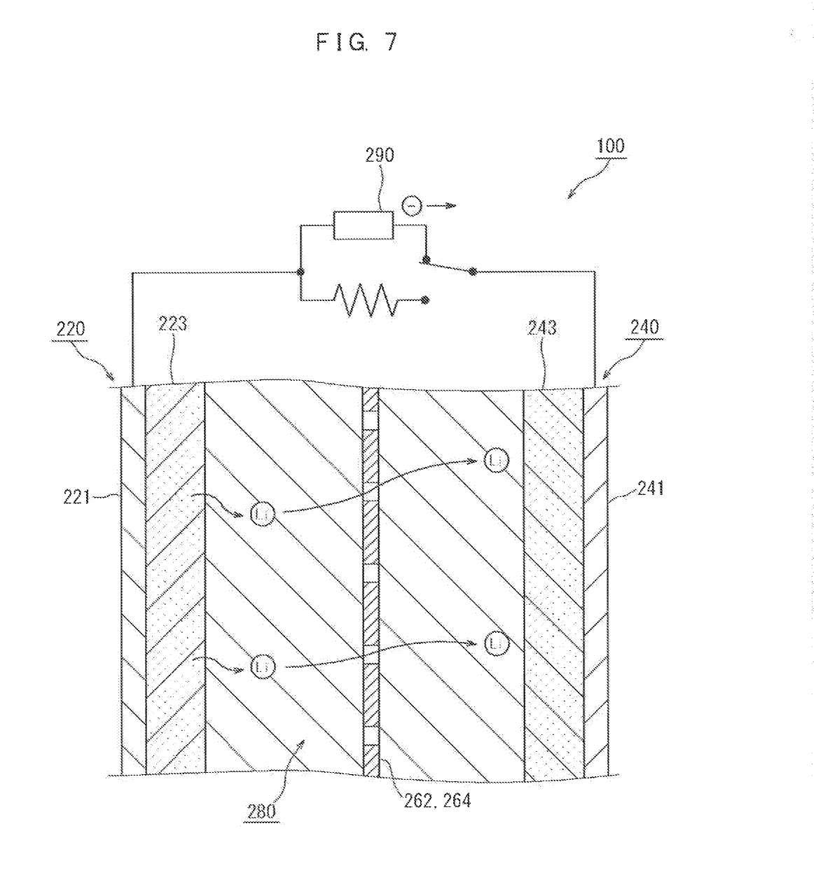

FIG. 7 schematically shows the state of the lithium-ion secondary battery 100 during charge. During charge, as shown in FIG. 7, the electrode terminals 420 and 440 (see FIG. 1) of the lithium-ion secondary battery 100 are connected to a charger 290. Due to the action of the charger 290, lithium ions (Li) are released from the positive electrode active material in the positive electrode active material layer 223 to the electrolyte 280 during charge. Electric charges are also released from the positive electrode active material layer 223. The released electric charges are transported through the conducting material (not shown) to the positive electrode current collector 221 and further to the negative electrode 240 through the charger 290. In the negative electrode 240, electric charges are stored and lithium ions (Li) in the electrolyte 280 are absorbed and stored in the negative electrode active material in the negative electrode active material layer 243.

<<Behavior During Discharge>>

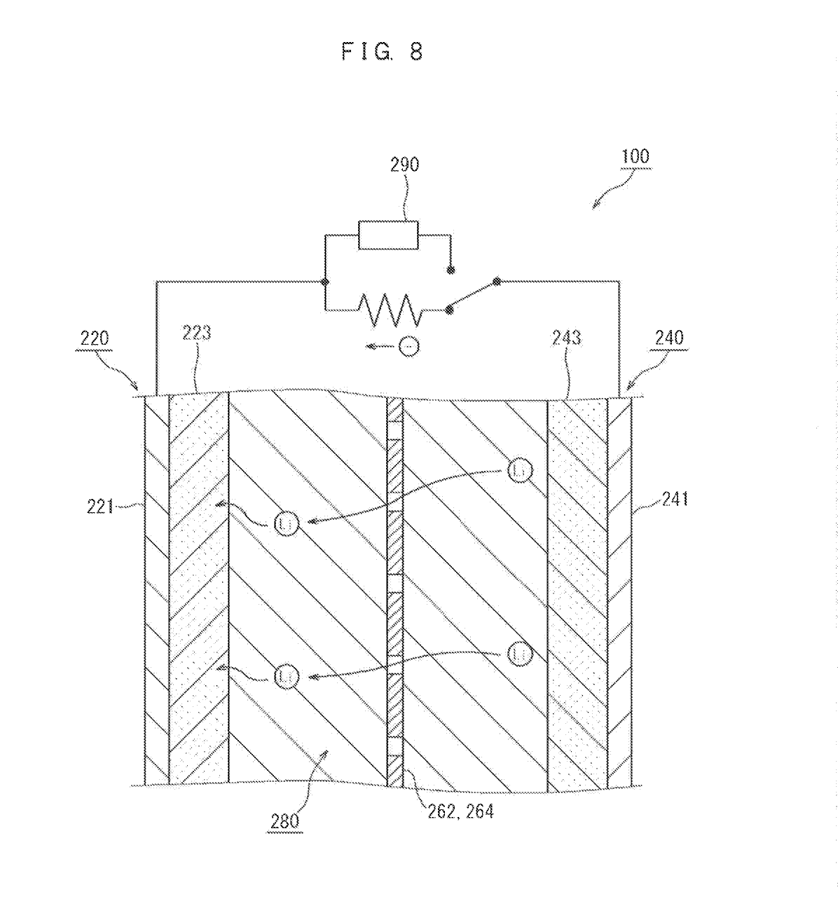

FIG. 8 schematically shows the state of the lithium-ion secondary battery 100 during discharge. During discharge, as shown in FIG. 8, electric charges are transported from the negative electrode sheet 240 to the positive electrode sheet 220 while lithium ions stored in the negative electrode active material layer 243 are released into the electrolyte 280. In the positive electrode, lithium ions in the electrolyte 280 are incorporated into the positive electrode active material in the positive electrode active material layer 223.

As described above, during charge and discharge of the lithium-ion secondary battery 100, lithium ions are transferred back and forth between the positive electrode active material layer 223 and the negative electrode active material layer 243 via the electrolyte 280. During charge, electric charges are transported from the positive electrode active material to the positive electrode current collector 221 via the conducting material, while during discharge electric charges are returned from the positive electrode current collector 221 to the positive electrode active material via the conducting material.

It is believed that the battery can be effectively and rapidly charged if lithium ions and electrons are transported as smoothly as possible during charge. It is believed that the power of the battery is improved if lithium ions and electrons are transported as smoothly as possible during discharge, resulting in decreased resistance and increased discharge amount of the battery. When the amount of lithium ions that are used for the battery reactions during charge or discharge is increased, the battery capacity may be considered to be increased.

<<Other Modes of Batteries>>

An example of lithium-ion secondary batteries has been described hereinabove. The lithium-ion secondary batteries are not limited to the above mode. Similar electrode sheets containing electrode mixtures applied on metal foils are used for other various modes of batteries. Other known modes of batteries include, for example, cylindrical batteries, laminated batteries and the like. The cylindrical batteries contain wound electrode assemblies harbored in cylindrical battery cases. The laminated batteries contain positive electrode sheets and negative electrode sheets laminated with separators existing therebetween.

The lithium-ion secondary battery according to an embodiment of the present invention is hereinafter described. The lithium-ion secondary battery described herein has the fundamental structure which is the same as that of the lithium-ion secondary battery 100 described above. Thus it is described by appropriately referring to the figures relating to the above lithium-ion secondary battery 100.

<<Structure of Separators 262 and 264>>

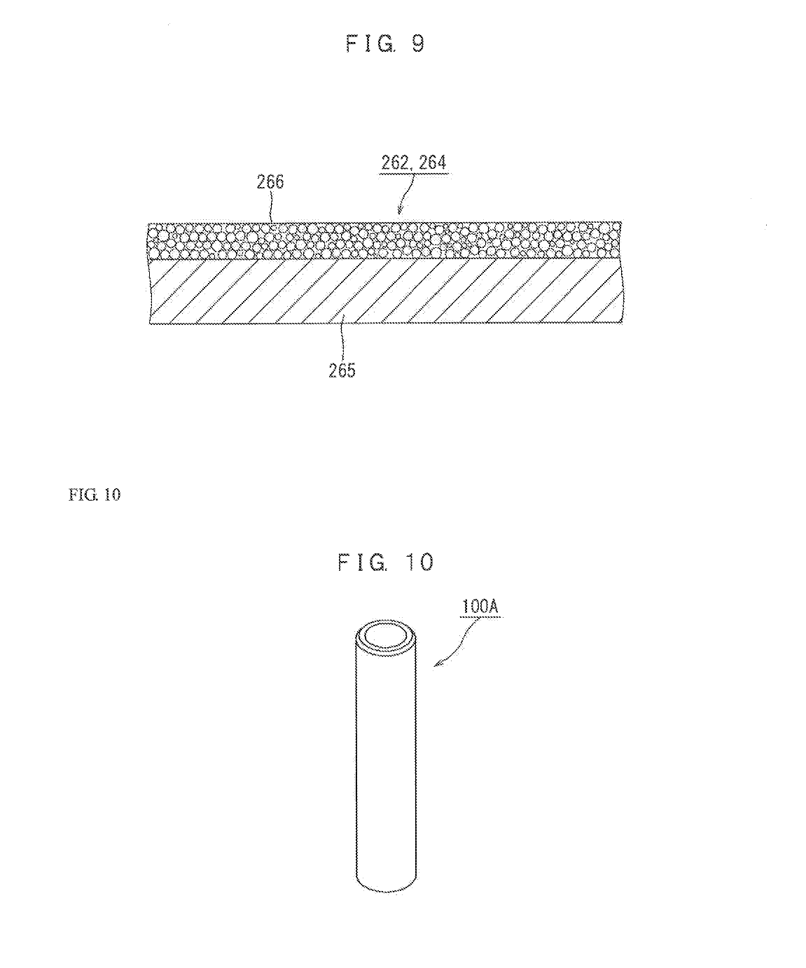

The structure of the separators 262 and 264 of the lithium-ion secondary battery 100 according to an embodiment of the present invention is hereinafter described in detail. The separators 262 and 264 are, as described above, disposed between the positive electrode active material layer 223 and the negative electrode active material layer 243. FIG. 9 shows a section view of the separators 262 and 264. The separators 262 and 264 include a separator substrate 265 and a heat-resistant layer 266.

### <<Separator Substrate 265>>

The separator substrate 265 is formed of a porous resin sheet. The separator substrate 265 may be formed of a porous resin sheet of, for example, a polyolefin resin. The separator substrate 265 has many fine pores which allow the electrolyte and lithium ions to pass through. The resin of the separator substrate 265 has a melting point of about 100° C. to 130° C., so that the resin of the separator substrate 265 melts when the battery abnormally generates heat due to overcharge and the like. Due to this, the fine pores of the separator substrate 265 are closed to block the passage of the electrolyte or lithium ions. Thus the separator substrate 265 has the function to prevent electric interengagement between the positive electrode and the negative electrode as well as the function to block the passage of the electrolyte or lithium ions by eliminating the pores at a predetermined temperature (shutdown function).

The separator substrate 265 may include the one having a single layer of a porous polyethylene (PE) and the one having three layers of polypropylene (PP)/polyethylene (PE)/polypropylene (PP). The separator substrate 265 appropriately has a thickness of about 10 μm to 40 μm, preferably 10 μm to 25 μm and particularly preferably 16 μm to 20 μm without particular limitation. The separator substrate 265 appropriately has a porosity (proportion of pores) of about 30% to 70%. For example, the separator substrate 265 having a single layer of a porous polyethylene (PE) preferably has a porosity of about 45% to 70%. The separator substrate 265 having three layers of polypropylene (PP)/polyethylene (PE)/polypropylene (PP) particularly preferably has a porosity of about 40% to 55%.

<<Method for Measuring Porosity (%)>>

The porosity (°/0) of the separator substrate 265 is measured as follows: first, the mass W of the separator substrate 265 and the apparent volume V of the separator substrate 265 are measured. From the mass W and volume V as well as the true density ρ of the subject the porosity can be calculated as: porosity (%)=(1−W/ρV)×100.

The porosity (%) of the separator substrate 265 may also be calculated by another method as follows: the volume Vo of voids in the separator substrate 265 is measured with a mercury porosimeter and then the porosity (%) can be calculated as a ratio (V/V) to the apparent volume (V) of the separator substrate 265.

The separators 262 and 264 respectively contain the separator substrate 265 onto which a heat-resistant layer 266 is formed. Thus upon measurement of the apparent volume V of the separator substrate 265, the average thickness of the separator substrate 265 may be determined as follows, for example.

A 5 cm×7 cm rectangular separator substrate 265 onto which the heat-resistant layer 266 is formed is measured for thickness with a macrometer at arbitrary 30 points. The thus obtained values for the thickness are averaged to calculate the thickness of the separator substrate 265 onto which the heat-resistant layer 266 is formed. Next, the separator substrate 265 is soaked with ethanol to remove the heat-resistant layer 266. The separator substrate 265 from which the heat-resistant layer 266 has been removed is measured for thickness in a similar manner with a macrometer at arbitrary 30 points. The thus obtained values for the thickness may be averaged to calculate the thickness of the separator substrate 265 only. The thickness of the heat-resistant layer 266 may be calculated by subtracting the thickness of the separator substrate 265 only from the thickness of the separator substrate 265 onto which the heat-resistant layer 266 is formed. The thickness of the separator substrate 265 only and the thickness of the heat-resistant layer 266 may be measured according to sectional SEM images of the separators 262 and 264.

<<Heat-Resistant Layer 266>>

The heat-resistant layer 266 is held on at least one side of the separator substrate 265. In this embodiment, the heat-resistant layer 266 contains an inorganic filler, a binder and a thickener.

<<Inorganic Filler>>

The inorganic filler contained in the heat-resistant layer 266 is preferably resistant to abnormal heat generation in the lithium-ion secondary battery and electrochemically stable within the range of use of the battery. The inorganic filler may include metal oxide particles and other metal compound particles. The inorganic filler may be exemplified by, for example, metal compounds such as alumina (Al₂O₃), alumina hydrates (e.g. boehmite (Al₂O₃.H₂O)), zirconia (ZrO₂), magnesia (MgO), aluminium hydroxide (Al(OH)₃), magnesium hydroxide (Mg(OH)₂), magnesium carbonate (MgCO₃) and titanium oxide (TiO₂). One, two or more of these metal compounds may be used as the inorganic filler contained in the heat-resistant layer 266.

Preferred, but not limiting, inorganic fillers are as follows:

alumina (D50=0.2 μm to 1.2 μm, BET=1.3 to 18 m²/g),
boehmite (D50=0.4 μm to 1.8 μm, BET=2.8 to 27 m²/g),
zirconia (D50=0.3 μm to 1.5 μm, BET 1.8 to 12 m²/g),
magnesia (D50=0.3 μm to 1.0 μm, BET=3.2 to 22 m²/g),
aluminium hydroxide (D50=0.8 μm to 2.6 μm, BET=3.9 to 32 m²/g),

wherein “D50” is an average particle diameter measured with, for example, a conventional commercially available particle size analyzer (laser diffraction particle size distribution analyzer etc.); and “BET” is a specific surface area measured according to a gas adsorption method (BET method, Harkins-Jura relative method).

<<Binder>>

The binder is a material which adheres the inorganic filler or the inorganic filler to the separator substrate 265 by the action of a dangling bond having an adhesive property when the binder is in a dry condition. The binder has a dangling bond having an adhesive property. With regard to the binder and the thickener used for the heat-resistant layer 266, the terms “adhesion” and “binding” are intended to have different meanings. The “adhesion” refers to the state where two objects are attached via the binder by chemical or physical force (e.g. ionic bond, covalent bond, Van der Wools force), while the “binding” refers to the state where two objects are fixed structurally (mechanically) via the binder. These definitions for “adhesion” and “binding” as used herein are not applied to the binder and the thickener used for the positive electrode active material layer 223 and the negative electrode active material layer 243.

The binder may include, for example, acrylic resins. The acrylic resins which may be preferably used are homopolymers obtained by polymerizing a single monomer such as acrylic acid, methacrylic acid, acrylamide, methacrylamide, 2-hydroxyethyl acrylate, 2-hydroxyethyl methacrylate, methacrylate, methyl methacrylate, ethylhexyl acrylate or butyl acrylate. The acrylic resin may also include copolymers obtained by polymerizing two or more monomers mentioned above. The acrylic resins may also include mixtures of two or more of the homopolymers and copolymers mentioned above. Other than the acrylic resins are mentioned styrene butadiene rubbers (SBRs), polyolefin resins such as polyethylene (PE), polytetrafluoroethylene (PTFE), polyvinylidene fluoride, polyacrylonitrile and polymethyl methacrylate.

<<Thickener>>

The thickener is a material which confers viscoelasticity suitable for application to slurry which is applied in the step of formation of the heat-resistant layer 266. The thickener as used herein is a material without a dangling bond having an adhesive property. The thickener which may be preferably used includes, for example, polymer materials such as carboxymethylcellulose (CMC), methylcellulose (MC), polyacrylic acid (PAA) and polyethylene oxide (PEO). The thickener acts to “bind” the inorganic filler and can cause aggregation of the inorganic filler in a solvent.

<<Formation of Heat-Resistant Layer 266>>

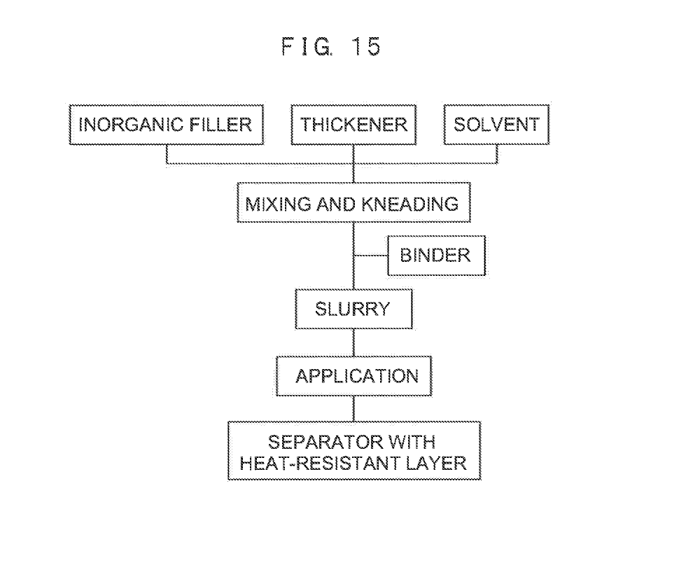

FIG. 15 is a process chart showing the formation of the heat-resistant layer 266. The heat-resistant layer 266 is held on the separator substrate 265. In this embodiment, the heat-resistant layer 266 is applied on the separator substrate 265. In the step of applying the heat-resistant layer 266, slurry (including paste or ink; the same applies hereinafter) containing the inorganic filler, the binder and the thickener which form the heat-resistant layer 266 at a certain proportion mixed and dispersed in a solvent is prepared. Upon this preparation, as shown in FIG. 15, the slurry solvent, the inorganic filler and the thickener at a certain proportion are mixed and then the binder is gradually added thereto while stirring. The concentration of the binder in slurry may be thus adjusted. Next, the prepared slurry (slurry for heat-resistant layer formation) is applied on the separator substrate 265. In the step of applying, an appropriate amount of shiny is applied on at least one surface of the separator substrate 265 and dried. Thus the separators 262 and 264 having the heat-resistant layer 266 can be formed.

<<Solvent for Slurry for Heat-Resistant Layer Formation>>

The solvent for the slurry may include organic solvents such as N-methylpyrrolidone (NMP), pyrrolidone, methyl ethyl ketone, methyl isobutyl ketone, cyclohexanone, toluene, dimethylformamide and dimethylacetamide and combinations of two or more of these. The solvent for slurry may alternatively be water or a mixed solvent which mainly contains water. The solvent other than water which is contained in such a mixed solvent may be one, two or more solvents appropriately selected from organic solvents (lower alcohols, lower ketones etc.) which are homogeneously miscible with water. The content of the solvent in slurry is preferably, but not limited to, about 30% by mass to 60% by mass of the total mass of the slurry and may be the amount suitable for application. The solvent for slurry is eliminated from the heat-resistant layer 266 in the step of drying.

The binder is selected according to the solvent used for slurry. When the solvent used for slurry is organic, the binder may be a polymer which is dispersed or solubilized in the organic solvent. The polymer which is dispersed or solubilized in the organic solvent may include, for example, acrylic resins described above, polyvinylidene fluoride, polytetrafluoroethylene (PTFE), polyacrylonitrile, polymethyl methacrylate and the like. When the solvent used for slurry is an aqueous solvent, the binder used is a polymer which is dispersed or solubilized in water. The polymer which is dispersed or solubilized in water may include, for example, styrene butadiene rubbers (SBR), polytetrafluoroethylene (PTFE), polyethylene (PE) and the like.

The material suitable for aqueous solvents, for example, is hydrophilic due to, for example, an aldehyde group (C—H—O). The dangling bond of the binder which has an adhesive property may include, for example, P (phosphorus) and SO₃ (sulfate group).

The slurry may be applied on the separator substrate 265 according to any well known methods used for application process. A certain amount of the slurry may be applied on the separator substrate 265 so as to form a layer coating by using, for example, an appropriate application apparatus (gravure coater, slit coater, die coater, comma coater, dip coat etc.). The slurry may be applied on the separator substrate 265 by not only the above methods but also by using printing techniques such as gravure printing or application techniques such as spraying. After applying the slurry along the longitudinal direction of the separator substrate 265 so as to obtain the layer, the separator substrate 265 with the applied slurry may be dried with an appropriate dryer.

The separators 262 and 264 may respectively contain the separator substrate 265 at least one surface of which has the heat-resistant layer 266. In this embodiment, the separator substrate 265 has the heat-resistant layer 266 on one surface. The separators 262 and 264 are respectively stacked so that the surface having the heat-resistant layer 266 faces the negative electrode active material layer 243. The separators 262 and 264 may be respectively stacked so that the surface having the heat-resistant layer 266 faces the positive electrode active material layer 223. When the separator substrate 265 has a single layer of a porous polyethylene (PE) and has the heat-resistant layer 266 on one surface, the heat-resistant layer 266 may be stacked so as to face the positive electrode active material layer 223. When the separator substrate 265 has three layers of polypropylene (PP) polyethylene (PE)/polypropylene (PP) and has the heat-resistant layer 266 on one surface, the heat-resistant layer 266 may be stacked so as to face any of the positive electrode active material layer 223 or the negative electrode active material layer 243. When the separator substrate 265 has three layers and has the heat-resistant layer 266 on one surface, the heat-resistant layer 266 is preferably stacked so as to face the negative electrode active material layer 241.

The heat-resistant layer 266 contains an inorganic filler, a binder and a thickener. The binder adheres the inorganic filler or the inorganic filler to the separator substrate 265. The heat-resistant layer 266 has many fine pores. The linkage between fine pores of the heat-resistant layer 266 allows passage of the electrolyte and lithium ions in the heat-resistant layer 266. The heat-resistant layer 266 is heat resistant such that it does not melt at a temperature range higher than the melting point of the separator substrate 265 (e.g. 150° C. or more). Even when the separator substrate 265 is deformed (shrank by heat or melted) upon heat generation of the battery, electric interengagement between the positive electrode and the negative electrode can be prevented by the heat-resistant layer 266. The heat-resistant layer 266 may appropriately have a thickness of, but not limited to, about 0.5 μm to 20 μm, preferably about 1 μm to 15 μm and particularly preferably about 3 μm to 10 μm.

<<Increased Resistance Due to High-Rate Charge and Discharge>>

The present inventor has been working in order to develop lithium-ion secondary batteries suitable for particularly hybrid vehicles (plug-in hybrid vehicles) in which the batteries are repetitively charged and discharged at a significantly high current value (high-rate) compared to home electric appliances. During the development, the present inventor variously studied, as described above, on the separators 262 and 264 which respectively contain the separator substrate 265 holding the heat-resistant layer 266. As a result, the separators 262 and 264 are found to have a tendency that they have increased direct-current resistance (IV resistance) when the battery is repetitively charged and discharged at high-rate. This tendency is more significant in a low temperature atmosphere around 0° C. The lithium-ion secondary batteries having increased direct-current resistance have an increased electric loss during charge and discharge, resulting in a decreased efficiency.

Although it has not been elucidated completely, the present inventor infers the cause for the above phenomenon as follows. The heat-resistant layer 266 contains some amount of dangling bonds in the binder. The dangling bonds in the binder may falsely capture lithium ions in the heat-resistant layer 266. When the dangling bonds substantially capture lithium ions in the electrolyte, the concentration thereof in the electrolyte is decreased.

In addition, upon repetitive high-rate charge and discharge during use of the lithium-ion secondary battery, the positive electrode active material layer 223 or the negative electrode active material layer 243 is expanded and shrunk accompanying with absorption and storage and release of lithium ions. Such expansion and shrinkage have a pumping effect so as to push the electrolyte out from the wound electrode assembly 200. Thus the lithium-ion secondary battery has, after repetitive high-rate charge and discharge, a decreased amount of the electrolyte in the wound electrode assembly 200.

The lithium-ion secondary battery containing the separators 262 and 264 including the heat-resistant layer 266 has decreased lithium ion concentration in the electrolyte because lithium ions in the electrolyte are substantially captured by the dangling bonds in the heat-resistant layer 266. Further, after repetitive high-rate charge and discharge, the amount of the electrolyte in the wound electrode assembly 200 is decreased. Thus the amount of lithium ions absorbed and stored to and released from the positive electrode active material layer 223 and the negative electrode active material layer 243 (in other words, utilized for battery reactions) is decreased. Due to these phenomena, the lithium-ion secondary battery 100 has increased resistance.

Further, under a low temperature atmosphere (e.g. a temperature atmosphere of about 0° C.), the electrolyte has an increased viscosity; facilitating the capture of lithium ions by the dangling bonds in the heat-resistant layer 266. Thus the above phenomena tend to be exhibited and the lithium-ion secondary battery 100 tends to have increased resistance under the usage conditions such as a low temperature and repetitive high-rate charge and discharge. Hybrid vehicles are required to secure certain performances even at such a low temperature atmosphere as below 0° C. and also required to carry out repetitive high-rate charge and discharge; thus there is a need for secondary batteries resistant to such a temperature or usage condition.

The present inventor has found that, with regard to the lithium-ion secondary battery 100 having the separators 262 and 264 which respectively contain the separator substrate 265 holding the heat-resistant layer 266, an increase in resistance in the lithium-ion secondary battery 100 can be prevented by increasing the amount of the thickener relative to that of the binder.

<<Weight Ratio P Between Binder and Thickener>>

Thus the present inventor prepared various samples having varied proportions between the binder and the thickener in the heat-resistant layer 266 and evaluated an extent of increase in resistance for the samples after high-rate charge and discharge. As a result, it was found that the increase in resistance can be reduced when the weight ratio P between the binder and the thickener (binder/thickener) is within a certain range.

The present inventor infers the reason for this phenomenon as follows. It is expected that the thickener can prevent the dangling bonds of the binder in the heat-resistant layer 266 from falsely capturing lithium ions. Thus when the amount of the thickener relative to the binder is more than a certain amount, a decreased amount of lithium ions may be falsely captured in the heat-resistant layer 266. On the other hand, when the amount of the thickener relative to the binder is less than a certain amount, an increased amount of lithium ions may be falsely captured in the heat-resistant layer 266 because the dangling bonds of the binder in the heat-resistant layer 266 are increased. As described above, in the heat-resistant layer 266, the thickener is expected to act so as to prevent the dangling bonds of the binder from capturing lithium ions.

Thus it is believed that when the weight ratio P between the binder and the thickener (binder/thickener) is within a certain range, the dangling bonds of the binder in the heat-resistant layer 266 are not significantly increased by the thickener, preventing incorporation of lithium ions in the electrolyte to the heat-resistant layer 266. Therefore the lithium-ion secondary battery 100 can be prevented, in some extent, from having increased resistance due to high-rate charge and discharge.

According to the findings by the present inventor, an increase in resistance after high-rate charge and discharge may be reduced in some extent when the weight ratio P between the binder and the thickener (binder/thickener) in the heat-resistant layer 266 is P<7.2. The weight ratio P between the binder and the thickener (binder/thickener) is preferably P<7.2, more preferably P about 7.0 and still more preferably P≦about 6.5. When the weight ratio P between the binder and the thickener (binder/thickener) is P>7.2, an increase in resistance after high-rate charge and discharge is significantly high with increase in the weight ratio P between the binder and the thickener (binder/thickener). No significant change in this tendency was observed with variation in the type of the inorganic filler, binder or thickener. At particularly P≦about 7.0 and still more preferably P≦about 6.5, an increase in resistance after high-rate charge and discharge can be reduced with higher confidence.

As described above, in the heat-resistant layer 266 the thickener is believed to prevent lithium ions from being captured by the dangling bonds of the binder. Therefore the thickener preferably satisfies, regardless of the appropriate amount for adjusting the viscosity of slurry, the weight ratio P between the binder and the thickener (binder/thickener) of P<7.2, more preferably P≦about 7.0 and still more preferably P≦about 6.5.

The amount of the binder in the heat-resistant layer 266 is adjusted to the amount which secures the function of the binder to adhere the inorganic filler or the inorganic filler to the separator substrate 265 and which allows formation of certain fine pores in the heat-resistant layer 266. In this viewpoint, the weight proportion of the binder in the heat-resistant layer may be 0.4 wt % or more and 17.2 wt % or less and more preferably 2.0 wt % or more and 4.5 wt % or less. The weight ratio P between the binder and the thickener (binder/thickener) may be, for example, 0.4≦P. Accordingly the heat-resistant layer 266 is prevented from having a significantly decreased peel strength.

No significant change in this tendency of the lithium-ion secondary battery 100 is observed with variation in the type of the inorganic filler, binder or thickener. The weight ratio P between the binder and the thickener (binder/thickener) in the heat-resistant layer 266 of 7.2 (P=7.2) does not necessarily correspond to the critical value for obtaining the increasing rate of resistance of the lithium-ion secondary battery of less than 1.2. However, the weight ratio P between the binder and the thickener (binder/thickener) in the heat-resistant layer 266 of less than 7.2 (P<7.2) allows reduction in the increasing rate of resistance of the lithium-ion secondary battery 100 in some extent. An increase in resistance after high-rate charge and discharge can be reduced with higher confidence at P about 7.0 and still more preferably P≦about 6.5, regardless of some variations in the effect due to variations in the type of the inorganic, filler, binder or thickener.

The effect of the thickener, namely prevention of the capture of lithium ions by the dangling bonds of the binder is described by referring to the test carried out by the present inventor.

<<Test Battery>>

FIG. 10 shows a test battery. The test battery 100A is, as shown in FIG. 10, a type 18650 battery. The type 18650 battery is a cylindrical lithium-ion battery with a diameter of 18 mm and a height of 650 mm (i.e. type 18650). The type 18650 battery contains a wound electrode assembly harbored in a case together with an electrolyte, the wound electrode assembly being obtained by stacking a positive electrode sheet and a negative electrode sheet together with two separators and winding the stacked sheets.

The positive electrode sheet used for this test contained LiNiCoMnO₂ (lithium nickel cobalt manganese composite oxide) as a positive electrode active material, acetylene black as a conducting material, polyvinylidene fluoride (PVDF) as a binder and an Al foil having a thickness of 15 μm as a positive electrode current collector. The positive electrode active material layer had an areal weight after drying of 9.8 mg/cm² to 15 mg/cm². The positive electrode active material layer had a density of 1.8 g/cm³ to 2.4 g/cm³.

The negative electrode sheet contained amorphous graphite (amorphous coated natural graphite) as a negative electrode active material, a styrene butadiene rubber (SBR) as a binder, carboxymethylcellulose (CMC) as a thickener and a copper foil having a thickness of 1.0 μm as a current collector. The negative electrode active material layer had an areal weight after drying of 4.8 mg/cm² to 10.2 mg/cm². The negative electrode active material layer had a density of 0.8 g/cm³ to 1.4 g/cm³.

The electrolyte was a non-aqueous electrolyte containing 1 mol/L of LiPF6 in a 3:7 (volume ratio) mixed solvent of ethylene carbonate (EC) and diethyl carbonate (DEC).

In this test, the separator was prepared by, as shown in FIG. 9, forming a heat-resistant layer (266) on a separator substrate (265). In this test, the separator substrate had three layers of PP/PE/PP. The separator substrate had a thickness of 16 μm to 20 μm mid a porosity of 40 to 55%.

The heat-resistant layer contains, as described above, an inorganic filler, a binder and a thickener. In this test, Table 1 shows the increasing rate of resistance after high-rate charge and discharge at a low temperature of the batteries in which the thickener used was carboxymethylcellulose with variations in the inorganic filler and binder and variations in the weight ratio P between the binder and the thickener (hinder; thickener).

<<Method for Measuring the Increasing Rate of Resistance after High-Rate Charge and Discharge at a Low Temperature>>

The increasing rate of resistance was obtained by providing a predetermined charge-discharge cycles to the test battery, measuring the value of resistance before and after the charge-discharge cycles and calculating the ratio of the values of resistance before and after the cycles (in this case, (value of resistance after charge-discharge cycles)/(value of resistance before charge-discharge cycles)). The evaluation at high-rate cycles was carried out in batteries containing short electrodes and having the 18650 size. In the evaluation, discharge was at a rate of 20 C for 10 seconds and charge was at a rate of 1 C for 200 seconds. The rest time (downtime) for transfer from discharge to charge was 5 seconds and the rest time (downtime) for the transfer from charge to discharge was 145 seconds. This charge-discharge cycle was repeated for 3000 times. In order to calculate the value of resistance after 1 cycle and after 3000 cycles, the battery was discharged at a rate of 20 C for 15 seconds respectively after 1 cycle and 3000 cycles and the reduction in the voltage ΔV was calculated. Based on the value of resistance Ra after 1 cycle and the value of resistance Rb after 3000 cycles, the increasing rate of resistance after 3000 cycles {(Rb−Ra)/Ra} was calculated. The degradation rate after high-rate cycles was evaluated based on the increasing rate of resistance.

Table 1 shows the composition of the heat-resistant layer and the increasing rate of resistance (increasing rate of resistance after high-rate charge and discharge at a low temperature) for the samples of test batteries used in the test. Table 1 shows, for the samples 1 to 30, the inorganic filler; the binder; the weight composition ratios of the binder and the thickener in the heat-resistant layer; the weight ratio P between the binder and the thickener (binder/thickener); and the increasing rate of resistance after high-rate charge and discharge at a low temperature in this order. The samples 1 to 30 shown in Table 1 had the same configurations except for the compositions of the heat-resistant layer of the separator.

TABLE 1

| | | | Weight | | Weight | |
|---|---|---|---|---|---|---|
| | | | composition | | ratio P | Increas- |
| Sam- | | | ratio | | Binder/ | ing rate |
| ple | Inorganic | | | Thick- | Thick- | of resis- |
| No. | filler | Binder | Binder | ener | ener | tance |
| 1 | Alumina | Acrylic | 0.4 | 1 | 0.4 | 1.14 |
| 2 | Alumina | Acrylic | 0.8 | 1 | 0.8 | 1.14 |
| 3 | Alumina | Acrylic | 1.9 | 1 | 1.9 | 1.15 |
| 4 | Alumina | Acrylic | 3.7 | 1 | 3.7 | 1.16 |
| 5 | Alumina | Acrylic | 5.6 | 1 | 5.6 | 1.16 |
| 6 | Alumina | Acrylic | 7.2 | 1 | 7.2 | 1.24 |
| 7 | Alumina | Acrylic | 8.5 | 1 | 8.5 | 1.44 |
| 8 | Alumina | Acrylic | 10.2 | 1 | 10.2 | 1.83 |
| 9 | Alumina | Acrylic | 2.7 | 1.8 | 1.5 | 1.16 |
| 10 | Alumina | Acrylic | 3.8 | 1.8 | 2.1 | 1.17 |
| 11 | Alumina | Acrylic | 2.8 | 2.4 | 1.2 | 1.16 |
| 12 | Alumina | Acrylic | 3.6 | 2.4 | 1.5 | 1.17 |
| 13 | Boehmite | Acrylic | 3.4 | 1 | 3.4 | 1.17 |
| 14 | Boehmite | Acrylic | 5.8 | 1 | 5.8 | 1.18 |
| 15 | Boehmite | Acrylic | 7.2 | 1 | 7.2 | 1.21 |
| 16 | Zirconia | Acrylic | 3.7 | 1 | 3.7 | 1.16 |
| 17 | Zirconia | Acrylic | 5.3 | 1 | 5.3 | 1.16 |
| 18 | Zirconia | Acrylic | 7.3 | 1 | 7.3 | 1.24 |
| 19 | Magnesia | Acrylic | 3.5 | 1 | 3.5 | 1.17 |
| 20 | Magnesia | Acrylic | 5.6 | 1 | 5.6 | 1.18 |
| 21 | Magnesia | Acrylic | 7.4 | 1 | 7.4 | 1.22 |
| 22 | Aluminium | Acrylic | 3.8 | 1 | 3.8 | 1.18 |
| | hydroxide | | | | | |
| 23 | Aluminium | Acrylic | 5.5 | 1 | 5.5 | 1.18 |
| | hydroxide | | | | | |
| 24 | Aluminium | Acrylic | 7.5 | 1 | 7.5 | 1.25 |
| | hydroxide | | | | | |
| 25 | Alumina | SBR | 5.2 | 1 | 5.2 | 1.18 |
| 26 | Alumina | SBR | 7.3 | 1 | 7.3 | 1.23 |
| 27 | Alumina | Polyolefin | 5.4 | 1 | 5.4 | 1.19 |
| 28 | Alumina | Polyolefin | 7.5 | 1 | 7.5 | 1.24 |
| 29 | Alumina | PTFE | 5.3 | 1 | 5.3 | 1.17 |
| 30 | Alumina | PTFE | 7.4 | 1 | 7.4 | 1.22 |

In the samples, the inorganic fillers used for the heat-resistant layers contained alumina, boehmite, zirconia, magnesia or aluminium hydroxide. For example, the heat-resistant layers respectively contained one binder selected from an acrylic hinder, a styrene butadiene rubber (SBR), a polyolefin binder and polytetrafluoroethylene (PTFE). All samples shown in Table 1 had the heat-resistant layer containing carboxymethylcellulose as the thickener.

The batteries having the weight ratio P between the binder and the thickener (hinder/thickener) of less than about 7.2 (P<7.2) had the increasing rate of resistance of less than 1.2. For example, the samples 6, 7, 8, 15, 18, 21, 24, 26, 28 and 30 having the weight ratio P (binder/thickener) of 7.2 or more generally have the increasing rate of resistance of more than 1.2. It is believed that this relation does not depend on the type of the inorganic filler or the type of the binder.

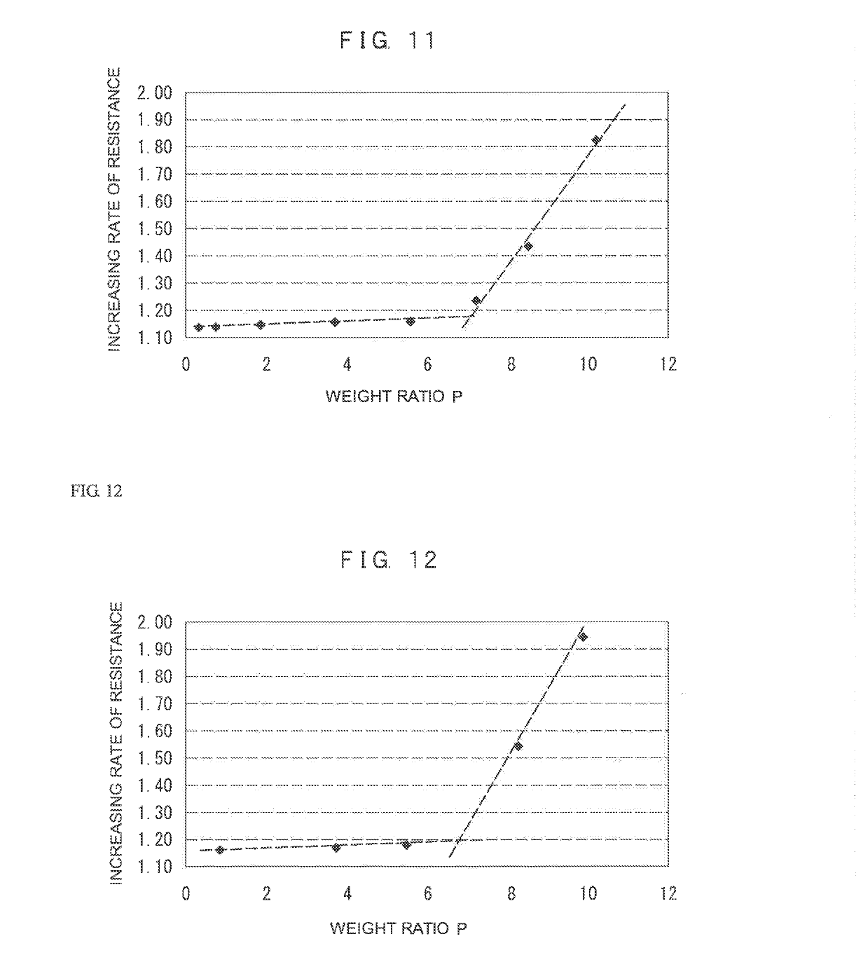

FIG. 11 is a graph showing correlation between the weight ratio P between the binder and the thickener (binder/thickener) and the increasing rate of resistance based on Table 1. As shown in FIG. 11, the batteries generally having the weight ratio P between the binder and the thickener (binder/thickener) of less than 7.2 (P<7.2) had low increasing rates of resistance of less than 1.2, while in the range of P≧7.2, the increasing rate of resistance tends to be significantly increased with the increase in the value of P.

The data shown in Table 1 is obtained for the batteries containing carboxymethylcellulose as a thickener. However, no significant effect on the tendency is observed with variation in the type of the thickener. FIG. 12 is a graph showing correlation between the weight ratio P between the binder and the thickener (binder/thickener) and the increasing rate of resistance for the batteries containing methylcellulose as a thickener. As shown in FIG. 12, for the batteries containing methylcellulose as a thickener, the increasing rate of resistance tends to be significantly increased with the weight ratio P between the binder and the thickener (binder/thickener) at or above a certain level. Namely, as shown in FIG. 12, the batteries generally having the weight ratio P between the binder and the thickener (binder/thickener) of P<7.2, the increasing rate of resistance is reduced, while in the range of P≧7.2, the increasing rate of resistance tends to be significantly increased with the increase in the value of P.

The present inventor speculates the reason for this tendency as follows: when the weight ratio P between the binder and the thickener (binder/thickener) in the heat-resistant layer 266 is high, lithium ions are facilitated to be captured by the dangling bonds of the binder in the heat-resistant layer 266, which increases the increasing rate of resistance of the lithium-ion secondary battery. When the weight ratio P between the binder and the thickener (binder/thickener) in the heat-resistant layer 266 is low, the thickener prevents the dangling bonds of the binder in the heat-resistant layer 266 from capturing lithium ions. Further, because the dangling bonds of the binder in the heat-resistant layer 266 capture less lithium ions in the electrolyte, the lithium-ion secondary battery may have a decreased increasing rate of resistance.

The results shown in Table 1, FIG. 11 or FIG. 12 support the above speculation. Further the present inventor hypothesized that, based on the above speculation, the increasing rate of resistance may be increased by increasing the thickness of the heat-resistant layer formed on the separator substrate. Thus, it is believed that by increasing the thickness of the heat-resistant layer, the binder in the heat-resistant layer 266 has increased dangling bonds when the weight ratio P between the binder and the thickener (binder/thickener) is the same. Then it is also believed that the heat-resistant layer 266 having increased dangling bonds of the hinder can capture more lithium ions in the electrolyte.

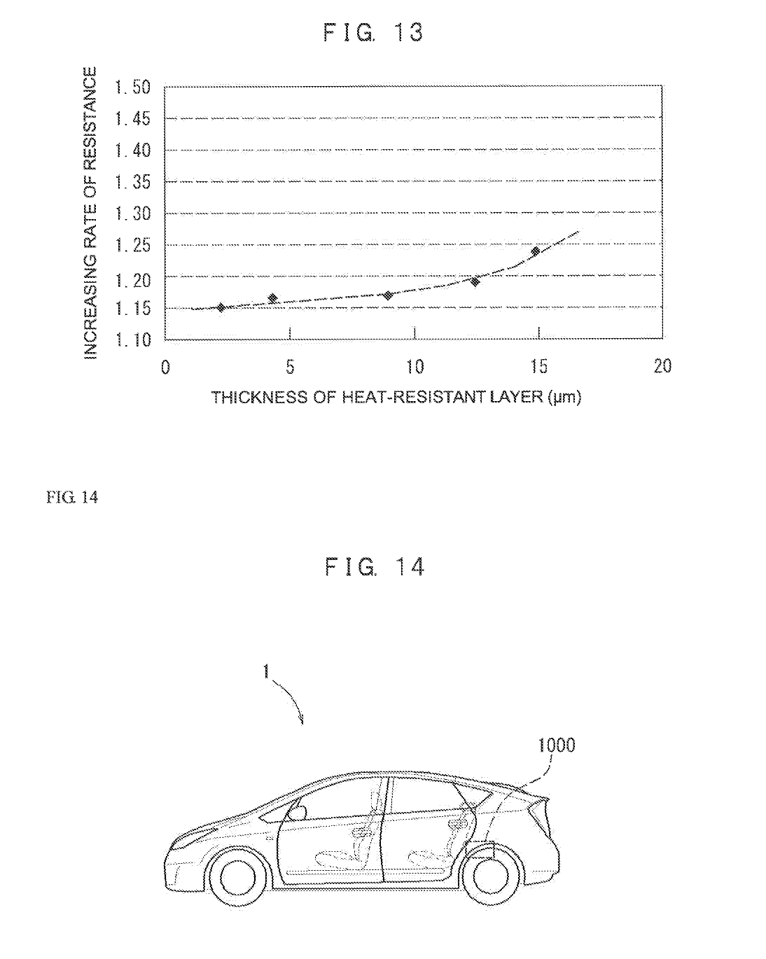

In order to verify the above hypothesis, the relation between the thickness of the heat-resistant layer formed on the separator substrate and the increasing rate of resistance was studied. FIG. 13 shows the relation between the thickness of the heat-resistant layer formed on the separator substrate and the increasing rate of resistance. The data shown in FIG. 13 were obtained from the samples of test batteries having the same configurations except for the thickness of the heat-resistant layer 266 in the test batteries. Particularly, the batteries had the same composition of the slurry for heat-resistant layer formation used for applying the heat-resistant layer 266 and the same weight ratio P between the binder and the thickener (binder/thickener).

In this case, as shown in FIG. 13, the lithium-ion secondary battery had an increased increasing rate of resistance when the thickness of the heat-resistant layer is increased. Accordingly, the results were obtained which agree with the speculation by the present inventor.

As described above, the lithium-ion secondary battery 100 according to an embodiment of the present invention includes, as shown in FIGS. 1 and 9, the separator substrate 265 which is disposed between the positive electrode active material layer 223 and the negative electrode active material layer 243 and formed of a porous resin sheet and a heat-resistant layer 266 held on the separator substrate 265. The heat-resistant layer 266 contains a inorganic filler, a binder and a thickener and has the weight ratio P between the binder and the thickener (binder/thickener) of P<7.2.

Accordingly, the lithium-ion secondary battery 100, despite containing the separators 262 and 264 having the heat-resistant layers 266, can have a reduced increasing rate of resistance under the use condition of repetitive high-rate charge and discharge.

The lithium-ion secondary battery according to an embodiment of the present invention has been hereinabove described. The present invention is not limited to any of the above embodiments unless otherwise stated.

As described above, the lithium-ion secondary battery, despite containing the separators 262 and 264 having the heat-resistant layers 266, can have a reduced increasing rate of resistance. Particularly the present invention allows improved reliability of the lithium-ion secondary battery in the use condition at a low temperature or with repetitive high-rate charge and discharge. Thus the present invention can be particularly suitably applied to lithium-ion secondary batteries for vehicles such as hybrid vehicles and electric vehicles which are required to have high output characteristics and stable performances. Thus the lithium-ion secondary battery according to an embodiment of the present invention may be, as shown in FIG. 14, suitably used as a battery 1000 (vehicle driving battery) for driving a motor (electric motor drive) of a vehicle 1 such as an automobile. The vehicle driving battery 1000 may be an assembled battery containing a plurality of secondary batteries.

### REFERENCE SIGNS LIST

1 Vehicle
100 Lithium-ion secondary battery
100A Test battery
200 Wound electrode assembly
220 Positive electrode sheet
221. Positive electrode current collector
222 Uncoated part
223 Positive electrode active material layer
224 Positive electrode mixture
224 Middle part
240 Negative electrode Sheet
241 Negative electrode current collector
242 Uncoated part
243 Negative electrode active material layer
244 Negative electrode mixture
262 Separator
264 Separator
265 Separator substrate
266 Heat-resistant layer
280 Electrolyte
290 Charger
300 Battery case
320 Case body
322 Joining part of the lid 340 and the case body 320
340 Lid
360 Safety valve
420 Electrode terminal
440 Electrode terminal
610 Positive electrode active material
620 Conducting material
630 Binder
71.0 Negative electrode active material
730 Binder
1000 Vehicle driving battery

1. A lithium-ion secondary battery comprising:
a positive electrode current collector;
a positive electrode active material layer held on the positive electrode current collector;
a negative electrode current collector;
a negative electrode active material layer that is held on the negative electrode current collector and covers the positive electrode active material layer;
a separator substrate disposed between the positive electrode active material layer and the negative electrode active material layer and formed of a porous polyolefin resin sheet; and
a heat-resistant layer held on the separator substrate,
wherein
the heat-resistant layer contains an inorganic filler, a polyolefin resin binder having a dangling bond, and a thickener without a dangling bond, and
the weight ratio P between the binder and the thickener (binder/thickener) is P<7.2.

2. The lithium-ion secondary battery according to claim 1, wherein the weight ratio P between the binder and the thickener (binder/thickener) is 0.4≦P.

3. The lithium-ion secondary battery according to claim 1, wherein the weight proportion of the binder contained in the heat-resistant layer is 0.4 wt % or more and 17.2 wt % or less.

4. The lithium-ion secondary battery according to claim 3, wherein the weight proportion of the binder is 2 wt % or more and 4.5 wt % or less.

5. The lithium-ion secondary battery according to claim 1, wherein the inorganic filler is at least one inorganic filler selected from the group of alumina (Al₂O₃), alumina hydrates (e.g. boehmite (Al₂O₃.H₂O)), zirconia (ZrO₂), magnesia (MgO), aluminium hydroxide (Al(OH)₃), magnesium hydroxide (Mg(OH)₂) and magnesium carbonate (MgCO₃).

6. (canceled)

7. The lithium-ion secondary battery according to claim 1, wherein the thickener is at least one thickener selected from the group of carboxymethylcellulose, methylcellulose, polyacrylic acid and polyethylene oxide.

8. A battery for a vehicle formed by the lithium-ion secondary battery according to claim 1.
